(19) United States
(12) Patent Application Publication
(10) Pub. No.: US 2017/0236417 A1
(43) Pub. Date: Aug. 17, 2017

(54) SENSOR APPARATUS, METHOD FOR ASCERTAINING A PARKING POSITION, AND METHOD FOR CREATING A DIGITAL PARKING AREA MAP

(71) Applicant: Robert Bosch GmbH, Stuttgart (DE)

(72) Inventor: Manuel Carrara, Heilbronn (DE)

(21) Appl. No.: 15/424,230

(22) Filed: Feb. 3, 2017

(30) Foreign Application Priority Data
Feb. 11, 2016 (DE) 102016202044.7

(51) Int. Cl. G08G 1/14

(52) U.S. Cl. CPC G08G 1/141

(57) ABSTRACT

A sensor apparatus for a parking space for motor vehicles. The sensor apparatus includes a parking occupancy sensor for detecting an occupancy state of a parking space for motor vehicles, and at least one sensor for measuring an environmental property of the parking space. A method for creating a digital parking area map and a method for ascertaining a parking position for a motor vehicle, as also described. An apparatus and a computer program are also described.

### CROSS REFERENCE

The present application claims the benefit under 35 U.S.C. §119 of German Patent Application No. DE 102016202044.7 filed on Feb. 11, 2016, which is expressly incorporated herein by reference in its entirety.

### FIELD

The present invention relates to a sensor apparatus for a parking space for motor vehicles. The present invention further relates to a method for ascertaining a parking position for a motor vehicle within a parking area encompassing several parking spaces. The present invention further relates to a method for creating a digital parking area map of a parking area for motor vehicles encompassing several parking spaces. The present invention further relates to an apparatus. The present invention furthermore relates to a computer program.

### BACKGROUND INFORMATION

U.S. Patent Appl. Pub. 2006/0250278 A1 describes a method and an apparatus for determining an availability of a plurality of parking spaces, and for reserving one or several available parking spaces. In the context of the method, a database that encompasses information regarding the availability of the several parking spaces is queried.

Parking occupancy sensors can be used, for example, to detect an occupancy state of a parking space. Parking occupancy sensors of this kind allow sensing of parking spaces in terms of their occupancy. Besides occupancy, meta-information items are also important; meta-information items encompass, for example, whether the parking space is a parking stall for residents, women, or the handicapped. Further meta-information items encompass, for example, information as to whether the parking space is covered, or whether the parking space offers easy loading and unloading capability.

The meta-information items described above supplement a digital parking area map with important information that goes beyond mere occupancy.

Further meta-information items encompass, for example, the information or indication as to whether there is in a vicinity of the parking spaces a tree or a building which mitigates solar irradiation into a vehicle interior of a motor vehicle parked in a parking space. Meta-information items of this kind can be derived, for example, from models and meteorological data. Such models and meteorological data can contain errors. The creation of such models, and the detection of such meteorological data, are furthermore generally complex and, in some circumstances, error-prone.

### SUMMARY

An object of the present invention is to provide for efficient detection of a meta-information item for a digital parking area map.

Advantageous embodiments of the present invention are described herein.

According to one aspect, a sensor apparatus for a parking space for motor vehicles is furnished, encompassing:
a parking occupancy sensor for detecting an occupancy state of a parking space for motor vehicles; and
at least one sensor for measuring an environmental property of the parking space.

According to another aspect, a method for ascertaining a parking position for a motor vehicle within a parking area encompassing several parking spaces, using several sensor apparatuses for a parking space for motor vehicles, is furnished, encompassing the following steps:
detecting a respective occupancy state of the parking spaces by way of the parking occupancy sensors;
measuring a respective environmental property of the parking spaces by way of the sensors;
selecting one of the several parking spaces, as a function of the detected occupancy states and of the measured environmental properties, as the parking position for the motor vehicle.

According to another aspect, a method for creating a digital parking area map of a parking area for motor vehicles encompassing several parking spaces, using several sensor apparatuses for a parking space for motor vehicles, is furnished, encompassing the following steps:
detecting a respective occupancy state of the parking spaces by way of the parking occupancy sensors;
measuring a respective environmental property of the parking spaces by way of the sensors;
creating the digital parking area map based on the detected occupancy states and on the measured environmental properties.

According to another aspect, an apparatus is furnished which is configured to carry out or execute the method for ascertaining a parking position for a motor vehicle within a parking area encompassing several parking spaces, and/or the method for creating a digital parking area map of a parking area for motor vehicles encompassing several parking spaces.

In accordance with a further aspect, a computer program is furnished which encompasses program code for carrying out the method for ascertaining a parking position for a motor vehicle within a parking area encompassing several parking spaces, and/or the method for creating a digital parking area map of a parking area for motor vehicles encompassing several parking spaces, when the computer program is executed on a computer, in particular on the apparatus.

In accordance with the present invention is, the above object may be achieved by the fact that a sensor apparatus is furnished which, in addition to a parking occupancy sensor, also encompasses a sensor for measuring an environmental property of the parking space. In other words, the sensor apparatus can therefore both detect an occupancy state of the parking space by way of the parking occupancy sensor, and on the other hand the sensor apparatus can measure an environmental property of the parking space by way of the sensor. The sensor apparatus thus has a dual function: detecting an occupancy state, and measuring an environmental property of the parking space. The sensor apparatus is thus efficiently used both to detect the occupancy state and to measure the environmental property.

The sensor apparatus can thus advantageously furnish two important information items for creating a digital parking area map: on the one hand the occupancy state of the parking space, and on the other hand an environmental property of the parking space, a so-called “meta-information item.” The digital parking area map can thus advantageously be created efficiently based on this information. In particular, the technical advantage thereby produced is that the parking position for a motor vehicle can be efficiently ascertained.

In accordance with the present invention, the information made available is not only whether the parking space is unoccupied or occupied. A measured environmental information item (a meta-information item) is also furthermore furnished. Real-time information is thus advantageously available, based upon which a parking position can be ascertained and/or a digital parking area map can be created. This therefore produces in particular the technical advantage that an efficient concept for efficient detection of a meta-information item for a digital parking area map is furnished.

A complex model calculation is therefore no longer necessary.

In addition, upon assembly of the apparatus not only the parking occupancy sensor but also the sensor for measuring an environmental property is assembled. Efficient assembly is thereby advantageously effected.

According to one embodiment, several sensors for measuring an environmental property of the parking space are provided.

According to one embodiment, several parking occupancy sensors for detecting an occupancy state of a parking space for motor vehicles are provided.

In one embodiment, a housing is provided in which and/or on which the parking occupancy sensor and/or the sensor are disposed. The parking occupancy sensor is thus, in particular, disposed in or on the housing. The sensor is thus, in particular, disposed in or on the housing. Disposition within the housing (in the housing) brings about efficient protection from external influences for the corresponding sensor. Disposition on the housing brings about efficient accessibility for the corresponding sensor for the purpose of maintenance or repair.

According to one embodiment, the parking occupancy sensor is a surroundings sensor selected from the following group of surroundings sensors: radar sensor, lidar sensor, laser sensor, ultrasonic sensor, video sensor, magnetic sensor, infrared sensor.

According to one embodiment, provision is made that the at least one sensor is an element selected from the following group of sensors: temperature sensor, moisture sensor, pressure sensor, brightness sensor, acoustic sensor, gas sensor, in particular ozone sensor, fine dust sensor, precipitation sensor, slickness sensor.

In the case of a temperature sensor, the environmental property is a temperature. In the case of a moisture sensor, the environmental property is a moisture. In the case of a pressure sensor, the environmental property is a pressure. In the case of a brightness sensor, the environmental property is a brightness. In the case of an acoustic sensor, the environmental property is a sound. It is thereby possible, for example, advantageously, to measure or ascertain a noise impact in an environment of the parking space. In the case of a gas sensor, the environmental property is, for example, a gas concentration. If the gas sensor is an ozone sensor, the environmental property is, for example, an ozone concentration. If the sensor is a fine dust sensor, the environmental property is, for example, a fine dust concentration. In the case of a precipitation sensor, the environmental property is a precipitation quantity. In the case of a slickness sensor, the environmental property is, for example, the indication as to whether or not a surface of the parking space is covered with ice.

In one embodiment, provision is made that the sensors encompass one or several temperature sensors, so that the measured environmental properties encompass temperatures, a respective time-related temperature profile of the temperature measured by way of the temperature sensor or sensors being monitored in order to detect a fire within the parking area and/or to track propagation of a detected fire within the parking area. This is because a spontaneous temperature rise is, as a rule, an indication of an incipient fire.

The monitoring encompasses, for example, comparing a measured temperature with a predetermined threshold value, a determination being made, as a function of the comparison, as to whether or not a fire is present within the parking area. If the temperature is greater than, or greater than or equal to, the threshold value, a determination is then made, for example, that a fire is present within the parking area.

The monitoring of the time-related temperature profile encompasses, for example, ascertaining a time derivative of the time-related temperature profile. If the time derivative is greater than, or greater than or equal to, a predetermined further threshold value, a determination is then made that a fire is present within the parking area. In other words, for example, the time derivative is compared, for example, with the predetermined further threshold value, a determination being made as a function of the comparison as to whether or not a fire is present within the parking area.

In one embodiment, provision is made that the sensors encompass one or several moisture sensors, so that the measured environmental properties encompass moisture values, a determination being made based on the measured moisture values as to whether a puddle is located on the parking space and/or whether it is currently raining.

In one embodiment, provision is made that a respective time-related moisture profile of the moisture values measured by way of the moisture sensor or sensors is ascertained, a drainage behavior of the puddle and/or of the rain on the corresponding parking space being determined based on the time-related moisture profiles.

Provision is made in particular that a precipitation estimate is carried out based on the time-related moisture profile.

Thanks to the use of additional sensors it is thus advantageously possible to derive further metadata (for example: presence of a fire, presence of a puddle, drainage behavior of a puddle, a precipitation quantity), which preferably become part of the digital parking area map and/or are incorporated into already existing meta-information items that, for example, already exist in a “smart city” infrastructure or are detected for such an infrastructure.

According to one embodiment, provision is made that a communication interface is provided which is configured to transmit a detected occupancy state and/or a measured environmental property via a communication network to at least one subscriber of the communication network.

This produces in particular the technical advantage that the detected occupancy state and/or the measured environmental property can be furnished efficiently.

The communication network encompasses, for example, a WLAN network and/or a mobile radio network.

According to one embodiment, provision is made that the at least one subscriber is a motor vehicle and/or a parking area management server for managing a parking area encompassing the parking space.

This produces the technical advantage, for example, that the motor vehicle can efficiently use the information (occupancy state and/or measured environmental property, i.e., the meta-information item) in order to ascertain an optimum parking space for parking.

The technical advantage produced is, in particular, the fact that the parking area management server can efficiently manage the parking area based on the conveyed information items (occupancy state and/or measured environmental property).

According to one embodiment, provision is made that the sensors encompass temperature sensors, so that the measured environmental properties encompass temperatures, the measured temperatures being differentiated over time in order to ascertain a respective shading and/or a respective weather protection for the parking spaces.

This produces in particular the technical advantage that a respective shading and/or a respective weather protection can be efficiently ascertained.

In accordance with a further embodiment, provision is made that for a plausibility check, the respective ascertained shading and/or the respective ascertained weather protection are reconciled with geographic data, the geographic data encompassing geographic positions of buildings and/or trees and/or bushes.

This produces in particular the technical advantage that the geographic data and/or the respective ascertained shading and/or the respective ascertained weather protection can be efficiently plausibilized with respect to one another. Specifically: if, for example, the geographic data specify that a tree must be located at a specific point within the parking space, but the ascertained shading and/or the ascertained weather protection indicate that a tree cannot be located at that point, it can be assumed in the context of the plausibility check that the geographic data are no longer current, for example because the tree has been cut back or removed.

According to one embodiment, the apparatus encompasses a communication interface that is configured to receive via a communication network a detected occupancy state of a parking space and/or a measured environmental property of a parking space. For example, the communication interface of the apparatus is configured to received the detected occupancy state and/or the measured environmental property from the sensor apparatus via the communication network.

According to one embodiment, the apparatus is configured, for example, as a parking area management server for managing the parking area.

According to one embodiment, the apparatus is configured as an apparatus for creating a digital parking area map of a parking area encompassing several parking spaces.

According to one embodiment, the apparatus is configured as an apparatus for ascertaining a parking position for a motor vehicle within a parking area encompassing several parking spaces.

According to one embodiment, the apparatus encompasses a processor. According to one embodiment, the processor is configured to create the digital parking area map based on the detected occupancy states and on the measured environmental properties.

According to one embodiment, the processor is configured to select one of the several parking spaces, as a function of the detected occupancy states and of the measured environmental properties, as the parking position for the motor vehicle.

In one embodiment, provision is made that the parking position is selected based on a digital parking area map of the parking area. The digital parking area map is, for example, the digital parking area map that was created in accordance with the method for creating a digital parking area map of a parking area encompassing several parking spaces.

Technical functionalities of the apparatus are evident analogously from corresponding technical functionalities of the method(s) and/or of the sensor apparatus, and vice versa. In other words, apparatus features are evident from corresponding method features, and vice versa.

The present invention is explained in further detail below with reference to preferred exemplifying embodiments.

### BRIEF DESCRIPTION OF THE DRAWINGS

FIG. 1 shows a sensor apparatus for a parking space for motor vehicles.

FIG. 2 is a flow chart of a method for ascertaining a parking position for a motor vehicle.

FIG. 3 is a flow chart of a method for creating a digital parking area map.

FIG. 4 shows an apparatus.

FIG. 5 shows a parking area.

### DETAILED DESCRIPTION OF EXAMPLE EMBODIMENTS

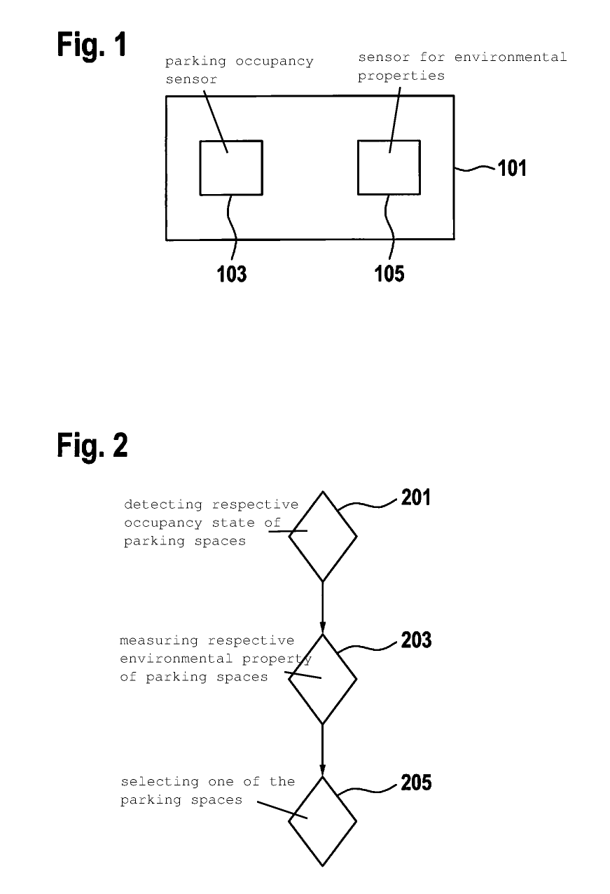

FIG. 1 shows a sensor apparatus 101 for a parking space for motor vehicles.

Sensor apparatus 101 encompasses a parking occupancy sensor 103 for detecting an occupancy state of a parking space for motor vehicles. Parking occupancy sensor 103 is, for example, a radar sensor. For example, parking occupancy sensor 103 is an ultrasonic sensor. In particular, parking occupancy sensor 103 is a magnetic sensor.

According to one embodiment, sensor apparatus 101 encompasses several parking occupancy sensors 103.

Sensor apparatus 101 further encompasses a sensor 105 for measuring an environmental property of the parking space. For example, sensor 105 is a temperature sensor for measuring a temperature. In other words, the temperature sensor can measure an ambient temperature of the parking space.

For example, sensor 105 is a brightness sensor for measuring a brightness in an environment of the parking space.

For example, sensor 105 is a fine dust sensor for measuring a fine dust concentration in an environment of the parking space.

For example, sensor 105 is an ozone sensor for measuring an ozone concentration in an environment of the parking space.

According to one embodiment, sensor apparatus 101 encompasses several sensors 105.

According to one embodiment, sensor apparatus 101 encompasses a communication interface. The communication interface is configured, for example, to transmit a detected occupancy state and/or a measured environmental property via a communication network to at least one subscriber of the communication network. The subscriber is, for example, a motor vehicle. The subscriber is, for example, a parking area management server. The subscriber is, for example, an apparatus in accordance with one embodiment of the present invention.

Provision is made according to one embodiment, for example, that an occupancy state of a parking space for motor vehicles is detected by way of sensor apparatus 101. According to one embodiment, provision is made in particular that an environmental property of the parking space is detected or measured by way of sensor apparatus 101.

According to a further embodiment, the detected occupancy state and/or the measured environmental property are made available to a parking area management server for managing a parking area encompassing several parking spaces. Provision is made, for example, that the parking area management server ascertains a parking position for a motor vehicle within the parking area, for example in accordance with a method in accordance with one embodiment of this invention for ascertaining a parking position for a vehicle.

According to one embodiment, provision is made that the parking area management server creates a digital parking area map of the parking area based on the occupancy state and/or on the environmental property, in particular in accordance with a method for creating a digital parking area map of a parking area for motor vehicles encompassing several parking spaces.

In other words, in particular, according to one embodiment the occupancy state and the measured environmental property are used to create a digital map of the parking area and/or to ascertain a parking position for a motor vehicle.

FIG. 2 is a flow chart of a method for ascertaining a parking position for a motor vehicle within a parking area encompassing several parking spaces, using several sensor apparatuses for a parking space for motor vehicles. The respective sensor apparatuses are, for example, sensor apparatus 101 of FIG. 1.

The method encompasses the following steps:
detecting 201 a respective occupancy state of the parking spaces by way of the parking occupancy sensors;
measuring 203 a respective environmental property of the parking spaces by way of the sensors;
selecting 205 one of the several parking spaces, as a function of the detected occupancy states and of the measured environmental properties, as the parking position for the motor vehicle.

According to one embodiment, provision is made that the sensors encompass temperature sensors, so that the measured environmental properties encompass temperatures, the measured temperatures being differentiated over time in order to ascertain a respective shading and a respective weather protection for the parking spaces.

According to one embodiment, provision is made that the selection is carried out as a function of the respective ascertained shading and/or the respective ascertained weather protection.

According to one embodiment, for example, provision is made that based on the respective ascertained shading and/or on the respective ascertained weather protection, an expected vehicle interior temperature at the end of a parking period of the motor vehicle is ascertained for each unoccupied parking space. Provision is made, for example, that the parking space selected as the parking position for the motor vehicle is the one that exhibits the lowest expected vehicle interior temperature of the ascertained vehicle interior temperatures.

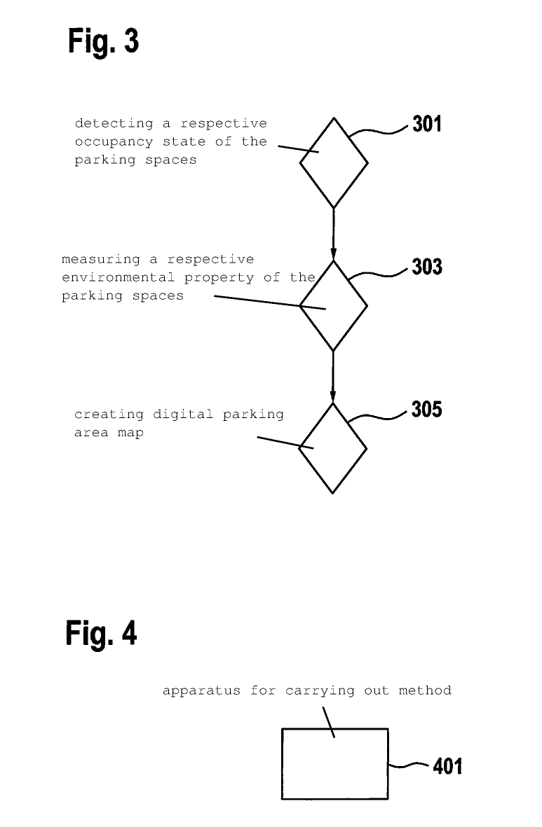

FIG. 3 is a flow chart of a method for creating a digital parking area map of a parking area for motor vehicles encompassing several parking spaces, using several sensor apparatuses for a parking space for motor vehicles. The respective sensor apparatuses are, for example, a sensor apparatus 101 in accordance with FIG. 1.

The method encompasses the following steps:
detecting 301 a respective occupancy state of the parking spaces by way of the parking occupancy sensors;
measuring 303 a respective environmental property of the parking spaces by way of the sensors;
creating 305 the digital parking area map based on the detected occupancy states and the measured environmental properties.

FIG. 4 shows an apparatus 401. Apparatus 401 is configured to execute or carry out the method for ascertaining a parking position and/or the method for creating a digital parking area map.

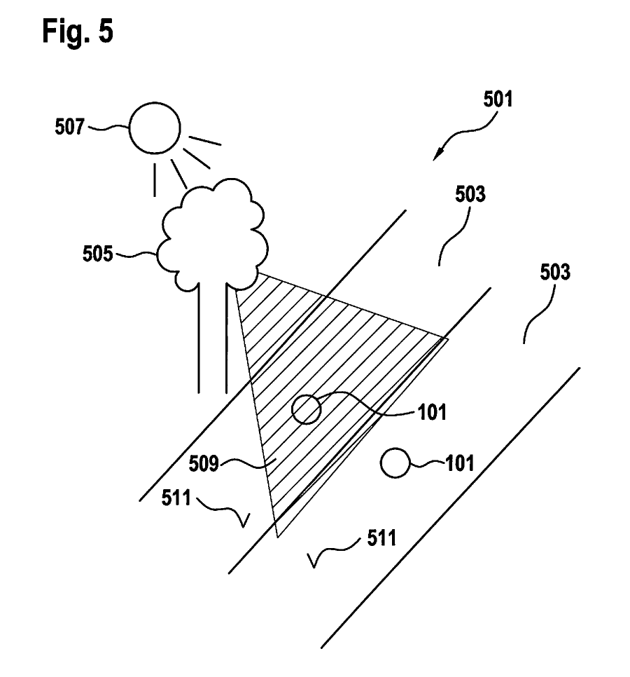

FIG. 5 shows a parking area 501 for motor vehicles.

Parking area 501 encompasses two parking spaces 503 in each of which a motor vehicle can park. A respective sensor apparatus 101 is disposed in or on surface 511 of parking spaces 503. Sensor apparatuses 101 thus detect a respective occupancy state of parking spaces 503. Sensor apparatuses 101 thus each measure a respective environmental property of parking spaces 503.

A tree 505 is disposed next to one of parking spaces 503. Tree 505 shades parking spaces 503 as a function of a current position of sun 507. A shaded region corresponding to the shading is drawn with hatching, and labeled with the reference character 509.

Outside shaded region 509, which can also be referred to as a “shaded region,” the corresponding regions or portions of parking spaces 503 are irradiated or insolated by sun 507.

With the sun position shown in FIG. 5, the left sensor apparatus 101 (referring to the plane of the paper) is thus located in shaded region 509. The right sensor apparatus 101 is located outside shaded region 509.

In one embodiment, the two sensor apparatuses 101 each encompass a temperature sensor for measuring an ambient temperature of parking spaces 503. The temperature sensors measure different ambient temperatures because of the shading. The temperature sensor that is located in shaded region 509 will measure a lower temperature than the temperature sensor that is located outside shaded region 509.

If the measured temperatures are then differentiated over time, it is then possible to ascertain thereby whether objects that result in shading, constituting causes of a differing temperature profile, must be located in the surroundings of parking spaces 503. For example, a temperature decrease indicates shading.

In other words, several temperature measurements are carried out by way of the temperature sensors over a predetermined time, so that a time-related temperature profile is ascertained. The time-related temperature profile is differentiated over time in order to ascertain a shading and/or a weather protection.

A shading and/or a weather protection is, for example, a tree and/or a building (in general, an object disposed in stationary fashion) and/or a bush.

According to one embodiment, these ascertained meta-information items are reconciled with geographic data, the geographic data encompassing geographic positions of buildings and/or trees and/or bushes. These geographic data can thereby be plausibilized. It is thereby possible, advantageously, to ascertain efficiently whether the geographic data are still current or may exhibit errors. Specifically, if the meta-information items ascertained by way of sensor apparatuses 101 indicate objects that are shading parking spaces 503, but the geographic data do not encompass such objects, it can be assumed that the geographic data are no longer current. The geographic data can thus, for example, be updated based on the meta-information items ascertained by way of sensor apparatuses 101.

It is advantageously possible, via temperature measurements by way of the temperature sensors, to infer the presence of a fire within the parking area and/or to track the propagation of a fire that is present.

It is advantageously possible, via moisture measurements by way of the moisture sensors, to infer the presence of a puddle in a parking space and/or to infer precipitation, for example rain; if a puddle is present, or in a context of current precipitation, a drainage behavior of the puddle, i.e., a drainage behavior of the water or the precipitation, on the parking space is in particular ascertained.

The concept according to the present invention can be used in particular within parking spaces and/or on a stretch of road, such provision being made according to one embodiment. Meta-information items for the parking space and/or the stretch of road can thereby advantageously be efficiently ascertained.

Meta-information items encompass, for example, one or several of the following meta-information items: ambient temperature, presence of a fire, presence of a puddle on the parking space, drainage behavior of water on the parking space, slickness on the parking space, quantity of precipitation on the parking space, shading, ozone concentration, fine dust load, noise impact, brightness.

What is claimed is:

1. A sensor apparatus for a parking space for a motor vehicle, comprising:
a parking occupancy sensor to detect an occupancy state of a parking space for a motor vehicle; and
at least one sensor to measure an environmental property of the parking space.

2. The sensor apparatus as recited in claim 1, wherein the at least one sensor to measuring the environmental property being an element selected from the following group of sensors: a temperature sensor, a moisture sensor, a pressure sensor, a brightness sensor, an acoustic sensor, a gas sensor, an ozone sensor, a fine dust sensor, a precipitation sensor, and a slickness sensor.

3. The sensor apparatus as recited in claim 1, further comprising:
a communication interface configured to transmit at least one of a detected occupancy state and a measured environmental property, via a communication network, to at least one subscriber of the communication network.

4. The sensor apparatus as recited in claim 3, wherein the at least one subscriber includes at least one of: i) a motor vehicle, and ii) a parking area management server for managing a parking area encompassing the parking space.

5. A method for ascertaining a parking position for a motor vehicle within a parking area encompassing several parking spaces, using several sensor apparatuses, each of the sensor apparatuses including a parking occupancy sensor to detect an occupancy state of a parking space for a motor vehicle, and at least one sensor to measure an environmental property of the parking space, the method comprising:
detecting a respective occupancy state of the parking spaces by way of the parking occupancy sensors; m
measuring a respective environmental property of the parking spaces by way of the sensors to measure the environmental property; and
selecting one of the several parking spaces, as a function of the detected occupancy states and of the measured environmental properties, as a parking position for the motor vehicle.

6. A method for creating a digital parking area map of a parking area for motor vehicles encompassing several parking spaces, using several sensor apparatuses, each of the sensor apparatuses including a parking occupancy sensor to detect an occupancy state of a parking space for a motor vehicle, and at least one sensor to measure an environmental property of the parking space, the method comprising:
detecting a respective occupancy state of the parking spaces by way of the parking occupancy sensors;
measuring a respective environmental property of the parking spaces by way of the sensors to measure the environmental property; and
creating the digital parking area map based on the detected occupancy states and on the measured environmental properties.

7. The method as recited in claim 6, wherein the sensors to measure the environmental property encompass temperature sensors so that the measured environmental properties encompass temperatures, the measured temperatures being differentiated over time in order to ascertain at least one of: i) a respective shading of the parking spaces, and ii) a respective weather protection for the parking spaces.

8. The method as recited in claim 7, wherein the at least one of the respective ascertained shading and the respective ascertained weather protection being reconciled with geographic data for a plausibility check, the geographic data encompassing geographic positions of at least one of: i) buildings, ii) trees, and iii) bushes.

9. The method as recited in one of claim 7, wherein a respective time-related temperature profile of the temperature measured by way of the temperature sensors are monitored to at least one of: i) detect a fire within the parking area, and ii) track propagation of a detected fire within the parking area.

10. The method as recited in claim 6, wherein the sensors to measure the environmental property encompass moisture sensors so that the measured environmental properties encompass moisture values, a determination being made based on the measured moisture values as to at least one of: i) whether a puddle is located on the parking space, and ii) whether it is currently raining.

11. The method as recited in claim 10, wherein a respective time-related moisture profile of the moisture values measured by way of the moisture sensors is ascertained, a drainage behavior of at least one of the puddle and the rain, on the corresponding parking space being determined based on the time-related moisture profiles.

12. An apparatus designed to ascertain a parking position for a motor vehicle within a parking area encompassing several parking spaces, using several sensor apparatuses, each of the sensor apparatuses including a parking occupancy sensor to detect an occupancy state of a parking space for a motor vehicle, and at least one sensor to measure an environmental property of the parking space, the apparatus designed to:
detect a respective occupancy state of the parking spaces by way of the parking occupancy sensors; m
measure a respective environmental property of the parking spaces by way of the sensors to measure the environmental property; and
select one of the several parking spaces, as a function of the detected occupancy states and of the measured environmental properties, as a parking position for the motor vehicle.

13. An apparatus designed to create a digital parking area map of a parking area for motor vehicles encompassing several parking spaces, using several sensor apparatuses, each of the sensor apparatuses including a parking occupancy sensor to detect an occupancy state of a parking space for a motor vehicle, and at least one sensor to measure an environmental property of the parking space, the apparatus designed to:
detect a respective occupancy state of the parking spaces by way of the parking occupancy sensors;
measure a respective environmental property of the parking spaces by way of the sensors to measure the environmental property; and
create the digital parking area map based on the detected occupancy states and on the measured environmental properties.

14. A non-transitory computer readable storage medium on which is stored a computer program to ascertain a parking position for a motor vehicle within a parking area encompassing several parking spaces, using several sensor apparatuses, each of the sensor apparatuses including a parking occupancy sensor to detect an occupancy state of a parking space for a motor vehicle, and at least one sensor to measure an environmental property of the parking space, the computer program, when executed by a processor, causing the processor to perform:
detecting a respective occupancy state of the parking spaces by way of the parking occupancy sensors; m
measuring a respective environmental property of the parking spaces by way of the sensors to measure the environmental property; and
selecting one of the several parking spaces, as a function of the detected occupancy states and of the measured environmental properties, as a parking position for the motor vehicle.
